(19) United States
(12) Patent Application Publication
(10) Pub. No.: US 2014/0258383 A1
(43) Pub. Date: Sep. 11, 2014

(54) System for serving a cross domain trade mark application interface

(71) Applicant: Nicholas Peter Milne, Sydney (AU)

(72) Inventor: Nicholas Peter Milne, Sydney (AU)

(21) Appl. No.: 14/191,433

(22) Filed: Feb. 27, 2014

(30) Foreign Application Priority Data
Feb. 27, 2013 (AU) 2013900661

(51) Int. Cl. H04L 29/08

(52) U.S. Cl. CPC H04L 67/10
USPC 709/203

(57) ABSTRACT

There is provided a server for serving a cross domain trade mark application interface. The server is adapted to serve, in response to a cross domain request from a browser application, interface markup language data, the interface markup language data defining at least a portion of the trade mark application interface, the trade mark application interface comprising at least one input field for inputting trade mark application data, the trade mark application data representing at least a trade mark representation; and receive, from the browser application via the network interface, the trade mark application data.

### FIELD OF THE INVENTION

The present invention relates to trade mark application software and in particular to a server for serving a cross domain trade mark application interface.

The invention has been developed primarily for use in facilitating trademark applications and will be described hereinafter with reference to this application. However, it will be appreciated that the invention is not limited to this particular field of use and may equally be applied for other intellectual property types, including patents and registered designs.

### BACKGROUND

A large portion of the work required in receiving trade mark application data from trade mark applicants may be automated including the automation of the goods and services classification and availability searching.

However, trademark service providers are traditionally not technically proficient and lack the requisite skills to provide such automation on their own websites which may comprise substantial reconfiguration of their back-end web servers.

As such, a need therefore exists for a system wherein trademark service providers may offer sophisticated trademark application interfaces on their own websites, such application interfaces offering automated goods and service classification, availability searching and the like.

It is to be understood that, if any prior art information is referred to herein, such reference does not constitute an admission that the information forms part of the common general knowledge in the art, in Australia or any other country.

### SUMMARY

The invention seeks to provide a server for serving a cross domain trademark application interface which will overcome or substantially ameliorate at least some of the deficiencies of the prior art, or to at least provide an alternative.

According to one aspect, there is provided a server for serving a cross domain trade mark application interface, the server comprising a processor for processing digital data; a memory device for storing digital data including computer program code, the memory device being operably coupled to the processor; and a network interface for sending and receiving data across a network, the network interface being operably coupled to the processor, wherein in use, the processor is controlled by the computer problem code to serve, in response to a cross domain request received via the network interface from a browser application, interface markup language data, the interface markup language data defining at least a portion of the trade mark application interface, the trade mark application interface comprising at least one input field for inputting trade mark application data, the trade mark application data representing at least a trade mark representation; and receive, from the browser application via the network interface, the trade mark application data.

Preferably, the processor is further controlled by the computer program code to store the trade mark application data in relation to a trade mark service provider id, the trade mark service provider id uniquely representing a trade mark service provider.

Preferably, the processor is further controlled by the computer program code to receive, from the browser application via the network interface, trade mark search query data, the trade mark search query data comprising at the least trade mark representation; and select, from trade mark database, trade mark search results data at least in accordance with the trade mark representation input data; and serve, to the browser application via the network interface, the trade mark search results data.

Preferably, the processor is controlled by the computer program code to select the trade mark search results data in accordance with a similarity algorithm.

Preferably, the similarity algorithm compares phonetic indices.

Preferably, the processor is further controlled by the computer program code to configure the interface markup language data in accordance with a configuration setting.

Preferably, the processor is controlled by the computer program code to receive, from the browser application via the network interface, the configuration setting.

Preferably, the memory device comprises configuration data representing the configuration setting, the at least one configuration setting stored in relation to the trade mark service provider id, and wherein the processor is further controlled by the computer program code to identify the trade mark service provider id in accordance with the cross domain request; and select, from the configuration data, the at least one configuration setting in accordance with the trade mark service provider id.

Preferably, the processor is controlled by the computer program code to identify the trade mark service provider id in accordance with the domain of the cross domain request.

Preferably, the processor is controlled by the computer program code to identify the trade mark service provider id in accordance with the HTTP_ORIGIN or HTTP_REFERRER header of the cross domain request.

Preferably, the configuration setting represents a selected country, and wherein the processor is further controlled by the computer program code to select, from the trade mark database, the trade mark search results data further in accordance with the selected country.

Preferably, the configuration setting represents a fee in relation to at least one of a trade mark application, a value added service and search option.

Preferably, the trade mark application interface comprises a goods and service input control for configuring at least one goods or service and wherein the trade mark search query data further comprises goods and service data and wherein the processor is further controlled by the computer program code to select, from the trade mark database, the trade mark search results data further in accordance with the goods and service data.

Preferably, the goods and service data comprises at least one goods or service string, and wherein the processor is further controlled by the computer program code to select, from a goods and service database, goods and service classification data representing at least one goods and service classification in accordance with the goods or service string; and send, to the browser application via the network interface, the goods and service classification data.

Preferably, the trade mark search query data further comprises goods and service classification data and wherein the processor is further controlled by the computer program code to select, from the trade mark database, the trade mark search results data further in accordance with the goods and service classification data.

Preferably, the processor is further controlled by the computer program code to select cross class classification data in accordance with the goods and service data; and select, from the trade mark database, the trade mark search results data further in accordance with the cross class classification data.

Preferably, the server is adapted to search the trade marks database in accordance with a first class of the classification data, and associate the trade mark search results with the cross class classification data.

Preferably, the processor is further controlled by the computer program code to send, to a financial transaction processing server via the network interface, financial transaction initiation instruction data.

Preferably, the financial transaction initiation instruction data represents an instruction to pay a trade mark service provider.

Other aspects of the invention are also disclosed.

### BRIEF DESCRIPTION OF THE DRAWINGS

Notwithstanding any other forms which may fall within the scope of the present invention, preferred embodiments of the invention will now be described, by way of example only, with reference to the accompanying drawings in which:

FIG. 1 shows a computing device on which the various embodiments described herein may be implemented in accordance with an embodiment of the present invention;

FIG. 2 shows a system for serving HTTP requests and the like across the Internet on which the various embodiments described herein may be implemented in accordance with an embodiment of the present invention;

FIG. 3 shows a system for serving a cross domain trademark application interface in accordance with a preferred embodiment of the present invention; and

FIGS. 4 to 8 shows exemplary embodiments of the trademark application interface of FIG. 3 in accordance with other embodiments of the present invention; and

FIGS. 9 to 15 shows exemplary embodiments of the back-end interface for allowing a trade mark service provider to configure the trademark application interface of FIG. 3 in accordance with other embodiments of the present invention

### DESCRIPTION OF EMBODIMENTS

It should be noted in the following description that like or the same reference numerals in different embodiments denote the same or similar features.

### Computing Device

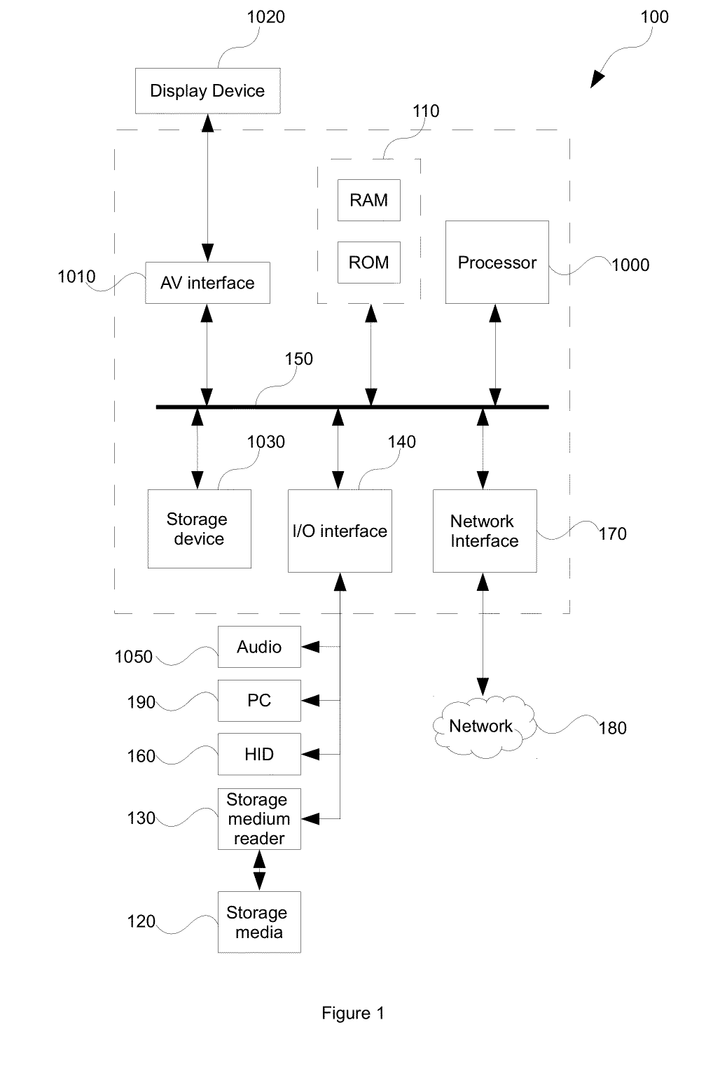

FIG. 1 shows a computing device 100 on which the various embodiments described herein may be implemented. In particular the steps of serving a cross domain trade mark application interface in the manner described herein may be implemented as computer program code instructions executable by the computing device 100. The computer program code instructions may be divided into one or more computer program code instruction libraries, such as dynamic link libraries (DLL), wherein each of the libraries performs a one or more steps of the method. Additionally, a subset of the one or more of the libraries may perform graphical user interface tasks relating to the steps of the method.

It should be noted that the computing device 100 may take on differing embodiments as the case may be. For example, the computing device 100 may take the form of a Web server 210 (as will be described in further detail below), which Web server may either be the back-end server 305 or the front end server 315 (which will also be described in further detail below) as the case may be. Alternatively, the computing device 100 may take the form of a client computing device 220 (as will also be described in further detail below) the client computing device 220 provided with a browser application 280 for managing HTTP requests and the like. The client computing device 220 may furthermore take on differing embodiments such as a personal computer desktop-based computing devices, or a mobile computing devices such as smart phones, tablet computing devices and the like.

The device 100 comprises semiconductor memory 110 comprising volatile memory such as random access memory (RAM) or read only memory (ROM). The memory 100 may comprise either RAM or ROM or a combination of RAM and ROM.

The device 100 comprises a computer program code storage medium reader 130 for reading the computer program code instructions from computer program code storage media 120. The storage media 120 may be optical media such as CD-ROM disks, magnetic media such as floppy disks and tape cassettes or flash media such as USB memory sticks.

The device further comprises I/O interface 140 for communicating with one or more peripheral devices. The I/O interface 140 may offer both serial and parallel interface connectivity. For example, the I/O interface 140 may comprise a Small Computer System Interface (SCSI), Universal Serial Bus (USB) or similar I/O interface for interfacing with the storage medium reader 130. The I/O interface 140 may also communicate with one or more human input devices (HID) 160 such as keyboards, pointing devices, joysticks and the like. The I/O interface 140 may also comprise a computer to computer interface, such as a Recommended Standard 232 (RS-232) interface, for interfacing the device 100 with one or more personal computer (PC) devices 190. The I/O interface 140 may also comprise an audio interface for communicate audio signals to one or more audio devices 1050, such as a speaker or a buzzer.

The device 100 also comprises a network interface 170 for communicating with one or more computer networks 180. The network 180 may be a wired network, such as a wired Ethernet™ network or a wireless network, such as a Bluetooth™ network or IEEE 802.11 network. The network 180 may be a local area network (LAN), such as a home or office computer network, or a wide area network (WAN), such as the Internet or private WAN.

The device 100 comprises an arithmetic logic unit or processor 1000 for performing the computer program code instructions. The processor 1000 may be a reduced instruction set computer (RISC) or complex instruction set computer (CISC) processor or the like. The device 100 further comprises a storage device 1030, such as a magnetic disk hard drive or a solid state disk drive.

Computer program code instructions may be loaded into the storage device 1030 from the storage media 120 using the storage medium reader 130 or from the network 180 using network interface 170. During the bootstrap phase, an operating system and one or more software applications are loaded from the storage device 1030 into the memory 110. During the fetch-decode-execute cycle, the processor 1000 fetches computer program code instructions from memory 110, decodes the instructions into machine code, executes the instructions and stores one or more intermediate results in memory 100.

In this manner, the instructions stored in the memory 110, when retrieved and executed by the processor 1000, may configure the computing device 100 as a special-purpose machine that may perform the functions described herein.

The device 100 also comprises a video interface 1010 for conveying video signals to a display device 1020, such as a liquid crystal display (LCD), cathode-ray tube (CRT) or similar display device.

The device 100 also comprises a communication bus subsystem 150 for interconnecting the various devices described above. The bus subsystem 150 may offer parallel connectivity such as Industry Standard Architecture (ISA), conventional Peripheral Component Interconnect (PCI) and the like or serial connectivity such as PCI Express (PCIe), Serial Advanced Technology Attachment (Serial ATA) and the like.

### Network of Computing Devices

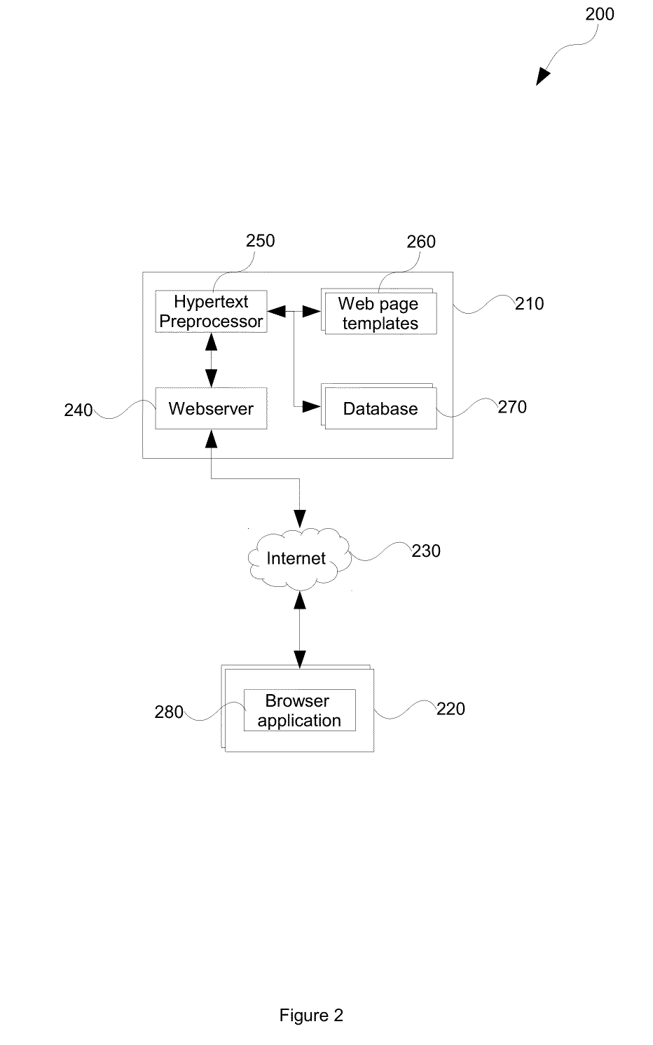

FIG. 2 shows a system 200 for serving HTTP requests and the like across the Internet 230 upon which the embodiments described herein may be implemented. The system 200 comprises a Web server 210 adapted for serving web pages and other digital content in response to HTTP requests and the like. As alluded to above, the Web server 210 may take on the embodiment of the back-end server 305 or the front-end server 315 (as will be described in further detail below) as the case may be.

The web server 210 is provided with a web server application 240 for receiving requests, such as Hypertext Transfer Protocol (HTTP) and File Transfer Protocol (FTP) requests, and serving hypertext web pages or files in response. The web server application 240 may be, for example the Apache™ or the Microsoft™ IIS HTTP server.

The web server 210 is also provided with a hypertext preprocessor 250 for processing one or more web page templates 260 and data from one or more databases 270 to generate hypertext web pages. The hypertext preprocessor may, for example, be the PHP: Hypertext Preprocessor (PHP) or Microsoft Asp™ hypertext preprocessor. The web server 210 is also provided with web page templates 260, such as one or more PHP or ASP files.

Upon receiving a request from the web server application 240, the hypertext preprocessor 250 is operable to retrieve a web page template, from the web page templates 260, execute any dynamic content therein, including updating or loading information from the one or more databases 270, to compose a hypertext web page. The composed hypertext web page may comprise client side code, such as Javascript, for Document Object Model (DOM) manipulating, asynchronous HTTP requests and the like.

The database 270 may comprise trade mark information for the purposes of conducting trade mark searches as will be described in further detail below. Furthermore, the trade mark data within the database 270 may be stored in relation to classification data so as to allow for trade mark searching within certain classes and cross classes. Furthermore, the database 270 may comprise classification data comprising a plurality of goods and services items stored in relation to class numbers so as to allow for the selection of appropriate goods and services classifications in accordance with the input goods and services items as will be described in further detail below.

Client computing devices 220 are provided with a browser application 280, such as the Mozilla Firefox™ or Microsoft Internet Explorer™ browser applications. The browser application 280 requests hypertext web pages from the web server 210 and renders the hypertext web pages on a display device 1020.

### A System for Serving a Cross Domain Trade Mark Application Interface

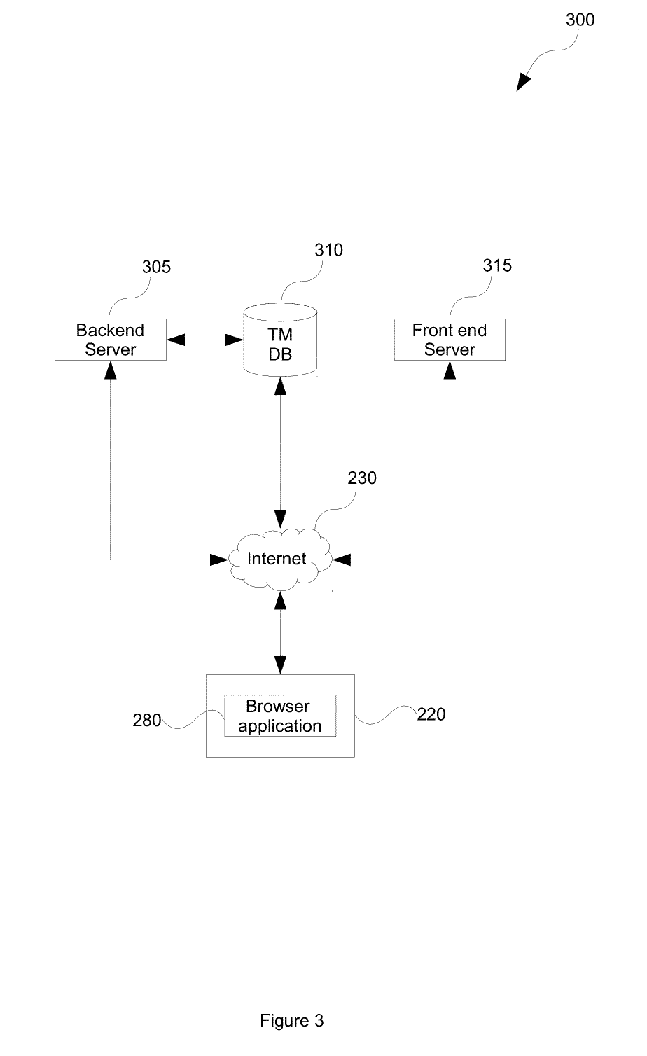

Turning now to FIG. 3, there is shown a system 300 adapted for serving a cross domain trade mark application interface. As will be described in further detail below, the system 300 allows for trade mark service providers to offer trade mark application interfaces on their own domains/web pages without having to invest in the back-end technical infrastructure, including that providing for goods and services classification, availability searching, application information input, payment processing and the like.

As will become apparent herein, the embodiments described herein will allow trade mark service providers to implement sophisticated trade mark application interfaces with a minimal coding, preferably by the insertion of a single line of JavaScript within a web page as will be described herein in further detail.

The system 300 comprises a back-end server 305 and a front-end server 315. It should be noted that the terminology “back-end” and “front end” should not be construed with any particular technical limitations in mind, but rather are for convenience only. As will become apparent from the description herein, the front-end server 315 is the server typically belonging to the trade mark service provider and the back-end server 305 is adapted for serving the trade mark application interface, conducting the trade mark availability searching, goods and services classifications and the like. As such, a request from the browser application 280 first served by the front-end server 315 to the back-end server 305 is referred to herein as “cross domain”. It should be noted that the back-end server 305 correlates with the term server as used in the accompanying claims.

As such, the back-end server 305 is adapted for serving a cross domain trade mark application interface. The back-end server 305 comprises a processor 1000 for processing digital data, a memory device (1030 and/or 110) for storing digital data including computer program code, the memory device being operably coupled to the processor; and a network interface 170 for sending and receiving data across a network 180 (preferably the Internet 230), the network interface 170 being operably coupled to the processor 1000.

As such, the processor 100 is controlled by the computer problem code to serve, in response to a cross domain request received via the network interface 170 from a browser application 280, interface markup language data, the interface markup language data defining at least a portion of the trade mark application interface, the trade mark application interface comprising at least one input field for inputting trade mark application data, the trade mark application data representing at least a trade mark representation.

Specifically, in order for a trade mark service provider or the like to offer the trade mark filing interface on their own webpage, the trade mark service provider would modify the appropriate web page 260 of the front-end server 315. Preferably, the Web page modified in this manner comprises client side code (such as JavaScript) adapted for causing the browser application 280 of the client computing device 220 to request the interface markup language data defining at least a portion of the trade mark application interface from the back-end server 305.

In a preferred embodiment, the implementation requires only a single line of JavaScript so as to allow the trade mark service provider who may not have a high degree of technical competence in implementing web applications to simply insert the single line of JavaScript into the appropriate web page templates 260. An exemplary HTML page comprising the single line of JavaScript may comprise:

<!DOCTYPE html>
<html>
<head></head>
<body>
<h1>Interface below</h1>
<script id=“api” src=“http://www.trade_markapi.com/js/api.js”></script>
</body>
</html>

As is apparent from the above HTML snippet, the HTML document comprises a single line of JavaScript pointing to a JavaScript file hosted preferably by the back-end server 305. For convenience, the JavaScript file is referred to herein as the “bootstrap” file as upon loading of the JavaScript file by the browser application 280, the bootstrap file will cause the browser application 280 to load the trade mark application interface.

In order to circumvent the same origin security policy enforced by modern browsers, the back-end server 305 may be adapted to implement the Cross-origin resource sharing (CORS) functionality wherein additional HTTP headers are set such that the browser application 280 will permit the cross origin or cross domain request to the backend server 305. Specifically, back-end server 305 may be configured such that upon receiving a request comprising the origin HTTP header, the back-end server 305 will respond with the Access-Control-Allow-Origin header specifying either the domain of the webpage or wildcard and the Access-Control-Allow-Origin header so as to allow for session control using the Access-Control-Allow-Credentials header.

Specifically, exemplary PHP code implement in the CORS mechanism may comprise:

if(isset($_SERVER[‘HTTP_ORIGIN’])){
header(“Access-Control-Allow-Origin:
”.$_SERVER[‘HTTP_ORIGIN’]);
header(“Access-Control-Allow-Credentials: true”);
}

In certain circumstances, the trade mark application interface will require additional resources including additional JavaScript files, CSS files and the like. In this manner, the bootstrap file may be adapted for causing the browser application 280 to request additional resources from the back-end server 305 (or any other server as the case may be). Specifically, exemplary JavaScript code for requesting additional JavaScript and resources may be provided as follows:

```
if (document.location.hostname == “localhost”)
    var api_domain=“”
else
    var api_domain=“http://www.trade markapi.com”
function load_scripts( ) {
    $.ajaxSetup ({
      cache: true
    });
    $.getScript(api_domain+‘/js/3.js’);
    $.getScript(api_domain+‘/js/2.js’);
    $.getScript(api_domain+‘/js/5.js’);
    $.getScript(api_domain+‘/js/6.js’);
    $.getScript(api_domain+‘/js/1.js’);
}
if(typeof jQuery==‘undefined’) {
    var headTag = document.getElementsByTagName (“head”) [0];
    var jqTag = document.createElement(‘script’);
    jqTag.type = ‘text/javascript’;
    jqTag.src = api_domain+‘/js/4.js’;
    if(jqTag.onreadystatechange!==undefined) { //only IE T_T
      jqTag.onreadystatechange = function( ) {
        load_scripts( );
      }
    }else
      jqTag.onload = load_scripts;
    headTag.appendChild(jqTag);
} else {
    load_scripts( );
}
```

Furthermore, exemplary JavaScript code for dynamically loading CSS data is provided as:

//load the CSS
if(!$(“#api_css”).exists( ))

| | |
|---|---|
| $(‘head’).append(‘<link id=“api_css” | rel=“stylesheet” |

href=“‘+api_domain+’/css/api.css” type=“text/css” />’);
if(!$(“#bootstrap_css”).exists( ))

| | |
|---|---|
| $(‘head’).append(‘<link id=“bootstrap_css” | rel=“stylesheet” |

href=“‘+api_domain+’/css/bootstrap_namespace.css” type=
“text/css” />’);
if(!$(“#datepicker_css”).exists( ))

| | |
|---|---|
| $(‘head’).append(‘<link id=“datepicker_css” | rel=“stylesheet” |

href=“’+api_domain+‘/css/datepicker.css” type=“text/css” />’);
if(!$(“#uploader_css”).exists( ))

| | |
|---|---|
| $(‘head’).append(‘<link id=“uploader_css” | rel=“stylesheet” |

href=“‘+api_domain+’/css/fineuploader-3.2.css” type=“text/css” />’);

Furthermore, the bootstrap file may be adapted for appending a container DIV (or the like) after the script so as to allow for a target container for the bootstrap file and other JavaScript resources to insert the trade mark filing interface. Specifically, exemplary JavaScript code for appending a container div is given as follows:

$(‘<div id=“api_container”></div>’).insertAfter(“#api”);

It should be noted that there are a number of other technical implementations that would allow a webpage served by the front-end server 350 to cause the browser application 280 to request the trade mark filing interface from the back-end server 305. These technical implementations include an IFrame which would cause the browser application 280 request the trade mark application interface data from the back-end server 305. While certainly feasible, iFrames are less preferred to the JavaScript implementation as described above as the trade mark application interface would be constrained within the boundaries of the iFrame (which boundaries may be dynamically resized of course but not without “bumping” other content). Conversely, the use of the above-mentioned JavaScript implementation allows the utilisation of the entire window of the browser application 280 including for in screen pop-up windows and the like.

A further alternative technical implementation, and one which would overcome the same origin security policy would be causing the browser application 280 to request the trade mark application interface data from the back-end server 305 via the front-end server 315. However, such an implementation, while certainly feasible, is not as preferred as the above-mentioned JavaScript implementation as it requires configuration of the front-end server 315 which defeats one of the advantages of the embodiments described herein of simplicity.

However, it is stressed herein that the term “cross domain”, “cross origin” or variations thereof as used herein should not be construed in a technically limiting manner including being limited to the above-mentioned JavaScript implementation of requesting data from the back-end server 305, but should rather be construed as being any manner by which a webpage served by the front-end server 350 may request data from the back-end server 305 (including by the front-end server 315 requesting such data in advance of serving the webpage such that the webpage need not specifically request the data itself), including by way of iFrame, requests via the front-end server 315 and the like.

It should be notes that the bootstrap file may be configured to fail over to fIXHR for those browsers not supporting CORS.

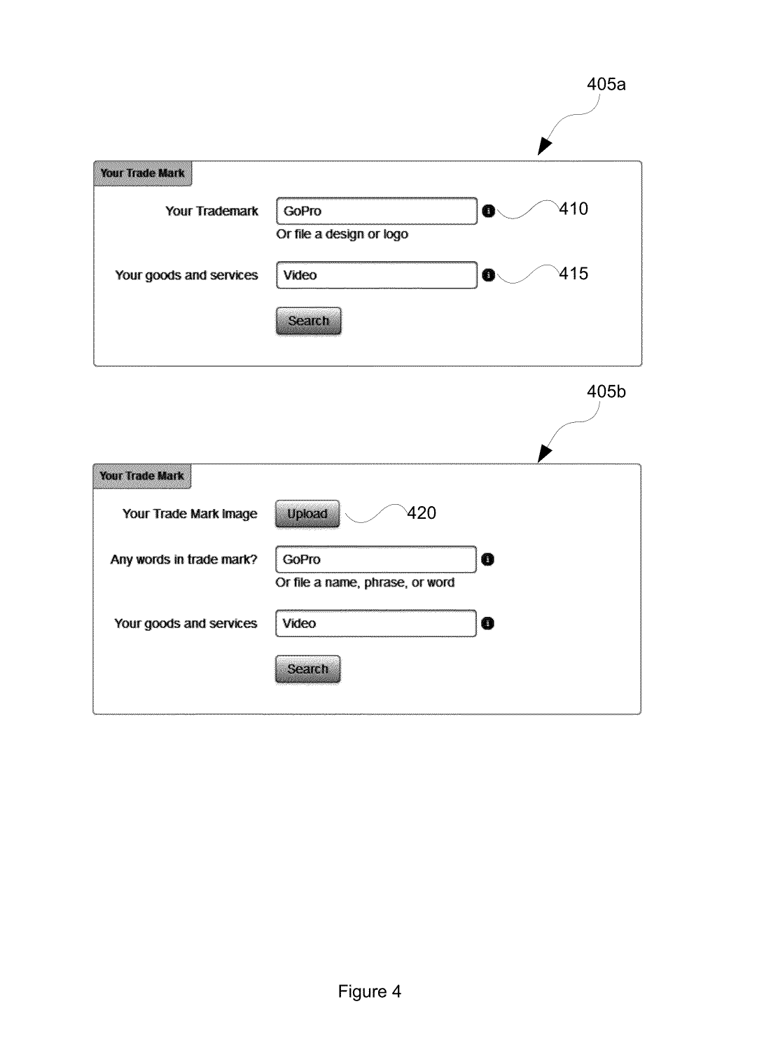

Turning now to FIG. 4, there is shown the trade mark application interface 405 in accordance with one embodiment. The trade mark application interface 405 is displayed by the browser application 280 after having requested the interface markup language data from the back-end server 305.

As is apparent, the application interface 405a comprises a number of input fields adapted for inputting trade mark application data by a user. As is also apparent from the exemplary embodiment provided in FIG. 4, the user has input a proposed trade mark representation of “GoPro” and a proposed goods and services item of “video”.

Referring also to the exemplary trade mark application interface 405b shown in FIG. 4, the trade mark application interface 405 is adapted for allowing users to input not only word trade mark applications but also design/logo trade mark applications. Preferably, the trade mark application interface 405 is adapted to transition between the word trade mark application interface 405a and the design trade mark application interface 405b by clicking on the “or file a design or logo” or “or file name, phrase or word” link. Preferably, such transition is done at the client side so as to eliminate the need for an HTTP request back to the back-end server 305 in order to transition the application interface 405.

The design trade mark application interface 405b is provided with suitable client side code so as to allow for the asynchronous upload of image data from the web browser application 280 to the back-end server 305.

The back-end server 305 is adapted for receiving, from the browser application 280, the trade mark application data having been input into the trade mark application interface 405. It should be noted that the trade mark application data may equally be sent via the front-end server 315 as alluded to above, however such would be less preferred as it would require the configuration of the front-end server 315.

Now, the back-end server 305 is adapted for configuration by one or more trade mark service providers for receiving trade mark applications on their own domains, as will be described in further detail below. Such configuration comprises a registration step, wherein the trade mark service provider will register their contact details for example. In this manner, upon receipt of the trade mark application dated by the back-end server 305, the back-end server 305 is adapted to store the trade mark application data in relation to a trade mark service provider id, the trade mark service provider id uniquely representing a trade mark service provider. In this manner, the trade mark service provider may subsequently authenticate with the back-end server 305 in order to retrieve the trade mark application details for filing and the like.

In a preferred embodiment, the back-end server 305 is adapted to send a notification (preferably by way of e-mail to the registered e-mail address for the service provider) to the service provider to notify the service provider of the trade mark application. In a yet further preferred embodiment as will be described in further detail below wherein the back-end server 305 is adapted to facilitate the processing of financial transactions in order to pay for the trade mark application, the back-end server 305 may be provided with a payment listener in order to listen for payments made using a payment gateway (such as PayPal) for the purposes of notifying the trade mark service provider regarding the payment for a trade mark application.

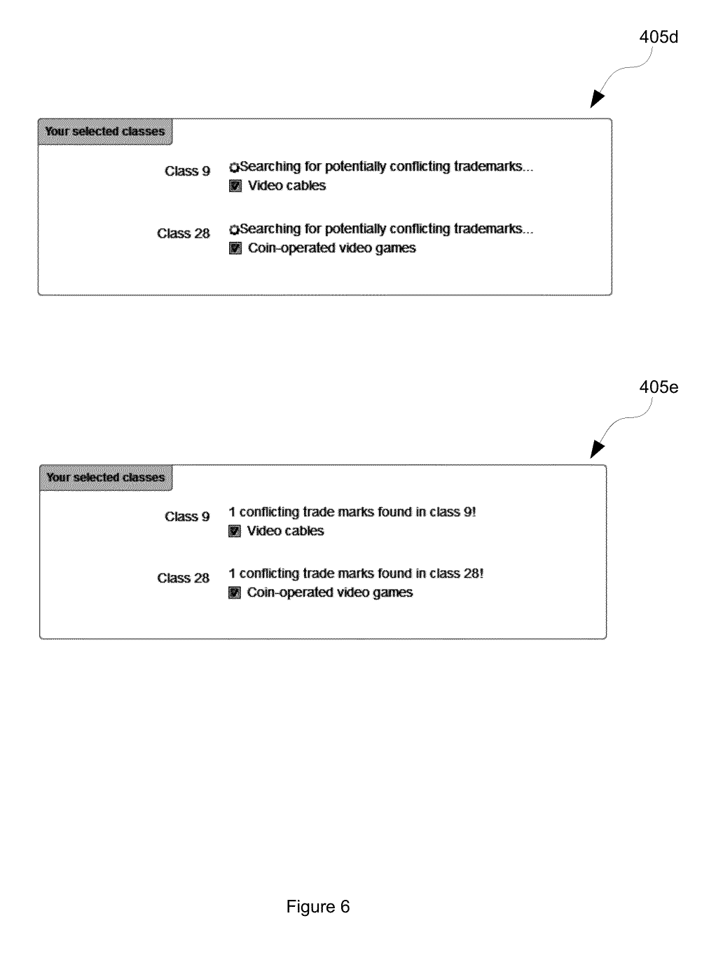

Referring now to FIG. 6, there is shown in an embodiment wherein the interface 405 is adapted to display search results of trade mark applications potentially conflicting with an input trade mark application. Specifically, with reference to interface 405d there is shown the interface 405d representing that the back-end server 305 is searching for potentially conflicting trade marks. As is evident, the interface 405d represents that availability searching is being performed per class, given as class 9 and class 28 in the interface 405d, and such will be described with reference to the preferred embodiment, the preferred embodiments including cross class availability searching. However, it should be noted that availability may be equally performed without reference to particular classes, in a less preferred embodiment.

As is evident from the exemplary interface 405e, the interface 405e represents that the system 300 has found one potentially conflicting trade mark found in class 9 and one potentially conflicting trade mark found in class 28.

Specifically now, the back-end server 305 is adapted to receive, from the browser application 280 via the network interface 170, trade mark search query data, the trade mark search query data comprising at the least trade mark representation (e.g. “GoPro” or words from within a design) and select, from trade mark database 310, trade mark search results data at least in accordance with the trade mark representation input data, and serve, to the browser application 280 via the network interface 170, the trade mark search results data.

The trade mark search query data may comprise only the trade mark representation, such as a GET or POST HTTP request comprising the trade mark representation, such as, using the examples provided in the drawings, “GOPRO”, or letters or words within a design trade mark representation.

As such, the back-end server 305 is adapted to select, from the trade mark database 310, potentially conflicting trade marks. It should be noted that the trade mark database 310 may be co-located with the back-end server 305, or may be communicable with the back-end server via the Internet 230.

The back-end server 305 may be adapted to select the trade mark search results in accordance with a similarity algorithm. In one embodiment, the back-end server 305 indexes the trade mark database 310 with a SOUNDEX index, so as to be able to efficiently and quickly select from the trade mark database 310 trade mark representations sounding like the trade mark search query. Of course, other similarity algorithm is may be employed also.

The back-end server 305 may select the potentially conflicting trade mark from the trade mark database 310 with a suitable SQL query, such as:

SELECT * FROM trade marks WHERE MATCH(representation) AGAINST (“GOPRO”)

or, where a similarity algorithm is employed:

SELECT * FROM trade marks WHERE soundex_representation=SOUNDEX(“GOPRO”)

Note that the trade marks data 310 need not necessarily be a relational database and may be a web service, web page or the like with which, the back-end server 305 is adapted to communicate (e.g. using JSON, SOAP, HTML or the like) for the purposes of selecting potentially conflicting trade marks.

In one embodiment, the back-end server 305 is adapted to cache potentially conflicting trade marks, preferably within an appropriate session variable, so as to eliminate a subsequent hit against the trade mark database 310 for the same trade mark search query. Also, the back-end server 305 may be adapted for storing any potentially conflicting trade marks identified for subsequent view by the trade mark service provider.

In a preferred embodiment, the back-end server 305 is adapted to perform trade mark availability searching in accordance with goods and services classifications so as to provide more relevant search results by returning only those trade mark search results being related by classification to the goods and services of the trade mark application.

Specifically, the back-end server 305 is adapted to select, from the trade mark database 310, the trade mark search results data further in accordance with the goods and service data.

Specifically, referring to the exemplary interface 405a as substantially shown in FIG. 4, there is shown a goods and service input field 415 adapted for allowing a trade mark applicant to input goods and services input strings, such as “video” in the example provided. A trade mark applicant may equally inputs other goods and services input strings, such as “computer software”, “beer” and the like. It should be noted that the input of goods and service strings as substantially provided in FIG. 4 and the selection of appropriate goods and services classifications in accordance with the goods and service brings is a preferred embodiment. However, it should be noted that in other embodiments, the trade mark application interface 405 may equally prompt the trade mark applicant to select the appropriate trade mark class in the first instance, such as wherein the trade mark applicant would simply select class 9 when applying for a trade mark application for computer software.

As such, having input the goods and service string (given as “video” in FIG. 4) the back-end server 305 is adapted to select, from a goods and service database (not shown), goods and service classification data representing at least one goods and service classification in accordance with the goods or service string; and send, to the browser application via the network interface, the goods and service classification data. It should be noted that the term “goods and service database” should not be construed in a technically limiting manner, such as by being a physically distinct database to the trade mark database 310. Rather, the term “goods and service database”, as is “trade marks database” should be construed in a purposive manner, that is, for the purposes of storing goods and service information.

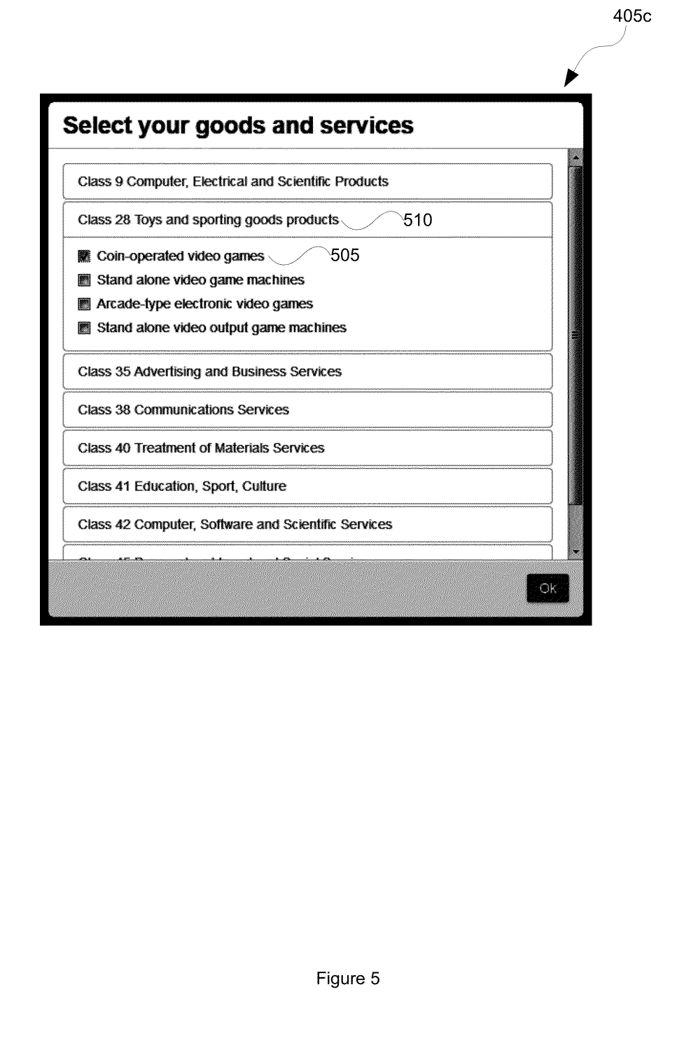

As such, and referring now to FIG. 5, there is shown the exemplary interface 405c showing the goods and service classification data. Specifically, the interface 405c shows a plurality of matching goods and services items 505 (such as from an official pick list), and the class 510 within which the goods and service item 505 falls.

For example, and using the example provided above, wherein the trade mark applicant has input the goods and service string “video”, the interface 405c shows a number of matching goods and service items 505, including those with in class 28 for toys and sporting goods products, comprising at least “coin operated videogames”, “stand-alone videogame machines”, “arcade type electronic videogames” and “stand-alone video output game machines”.

Using the interface 405c, the trade mark applicant is able to select at least one goods and service item 505 for inclusion within the trade mark application. In one embodiment, where no goods and service item 505 matches the trade mark applicant's intention exactly, the interface 405c may be adapted for allowing the trade mark applicant to edit, or insert a new goods and service item 505.

In a yet further embodiment, where no goods and services items are found by the back-end server 305 matching the trade mark applicant's goods and services input string, the back-end server 305 may be configured to class, such as class 35 for advertising and business services, for inclusion of the trade mark applicant's goods and services input string so to avoid presenting a message to the trade mark applicant that no goods and services have been found matching the trade goods and services input string. In this embodiment, the back-end server 305 may be configured to set a flag against the trade mark application data so as to alert the trade mark service provider that the trade mark applicant to input string may not necessarily be classified in the correct class, and that the trade mark service provider should manually review the goods and services input strings to ascertain the most appropriate class.

Now, the trade mark applicant having selected at least one goods and service item in the manner described above, in selecting potentially conflicting trade marks, the back-end server 305 is adapted to select, from the trade mark database 310, the trade mark search results data further in accordance with the goods and service classification data.

For example, the following SQL query example may be used:

SELECT * FROM trade marks JOIN classes USING(number) WHERE
MATCH(representation) AGAINST (“GOPRO”) AND (class=
9 OR class=28)

As such, and referring to the embodiment provided in FIG. 6, the back-end server 305 would search the trade mark database 310 in accordance with class 9 and class 28 and present to the trade mark applicant, an indication as to whether potential conflicting trade marks have been found within each class.

In a preferred embodiment, the back-end server 305 is adapted to employ cross class searching for the purposes of identifying potentially conflicting trade marks within classes which are related to the trade mark applicant is selected classes. Specifically, the back-end server 305 is adapted to select cross class classification data in accordance with the goods and service data and select, from the trade mark database, the trade mark search results data further in accordance with the cross class classification data. Referring to the following table, there is shown a cross class matrix showing the class is related to each of the 45 trade mark classes:

| | | | | | | | | | | | | | | | |
|---|---|---|---|---|---|---|---|---|---|---|---|---|---|---|---|
| Class 1 | 1 | 31 | | | | | | | | | | | | | |
| Class 2 | 2 | | | | | | | | | | | | | | |
| Class 3 | 3 | 5 | 21 | | | | | | | | | | | | |
| Class 4 | 4 | 39 | 13 | | | | | | | | | | | | |
| Class 5 | 3 | 5 | 10 | 30 | 31 | 32 | 29 | | | | | | | | |
| Class 6 | 6 | 17 | 19 | 20 | 22 | 37 | | | | | | | | | |
| Class 7 | 7 | 8 | 11 | 12 | 21 | 9 | | | | | | | | | |
| Class 8 | 7 | 8 | 21 | 9 | | | | | | | | | | | |
| Class 9 | 9 | 16 | 28 | 37 | 38 | 41 | 42 | 45 | 11 | | | | | | |
| Class 10 | 5 | 10 | 11 | | | | | | | | | | | | |
| Class 11 | 7 | 11 | 17 | 19 | 21 | 37 | 10 | 11 | | | | | | | |
| Class 12 | 7 | 12 | 35 | 37 | 42 | | | | | | | | | | |
| Class 13 | 13 | 37 | | | | | | | | | | | | | |
| Class 14 | 14 | 21 | 35 | 37 | 40 | 42 | | | | | | | | | |
| Class 15 | 15 | | | | | | | | | | | | | | |
| Class 16 | 9 | 16 | 41 | 42 | | | | | | | | | | | |
| Class 17 | 6 | 11 | 17 | 19 | 37 | | | | | | | | | | |
| Class 18 | 18 | | | | | | | | | | | | | | |
| Class 19 | 6 | 11 | 17 | 19 | 37 | | | | | | | | | | |
| Class 20 | 6 | 20 | 21 | 24 | | | | | | | | | | | |
| Class 21 | 3 | 7 | 8 | 11 | 14 | 20 | 21 | 9 | 26 | | | | | | |
| Class 22 | 6 | 22 | | | | | | | | | | | | | |
| Class 23 | 23 | 26 | | | | | | | | | | | | | |
| Class 24 | 20 | 24 | 27 | 40 | | | | | | | | | | | |
| Class 25 | 25 | 35 | 40 | 42 | | | | | | | | | | | |
| Class 26 | 23 | 26 | 22 | | | | | | | | | | | | |
| Class 27 | 24 | 27 | 37 | | | | | | | | | | | | |
| Class 28 | 9 | 28 | | | | | | | | | | | | | |
| Class 29 | 29 | 30 | 32 | 5 | | | | | | | | | | | |
| Class 30 | 5 | 29 | 30 | 31 | 43 | | | | | | | | | | |
| Class 31 | 1 | 5 | 29 | 30 | 31 | | | | | | | | | | |
| Class 32 | 5 | 29 | 32 | 33 | | | | | | | | | | | |
| Class 33 | 32 | 33 | | | | | | | | | | | | | |
| Class 34 | 14 | 34 | | | | | | | | | | | | | |
| Class 35 | 12 | 14 | 25 | 35 | 36 | 40 | 42 | 43 | 41 | | | | | | |
| Class 36 | 35 | 36 | 41 | 42 | 43 | 37 | | | | | | | | | |
| Class 37 | 9 | 11 | 12 | 13 | 14 | 17 | 19 | 27 | 37 | 38 | 42 | 44 | 6 | 36 | 40 |
| Class 38 | 9 | 35 | 37 | 38 | 41 | 42 | | | | | | | | | |
| Class 39 | 4 | 35 | 39 | 42 | 43 | | | | | | | | | | |
| Class 40 | 14 | 24 | 25 | 40 | 42 | 37 | 43 | | | | | | | | |
| Class 41 | 9 | 16 | 36 | 38 | 41 | 42 | 43 | 35 | | | | | | | |
| Class 42 | 9 | 12 | 14 | 16 | 25 | 35 | 37 | 38 | 40 | 42 | 43 | | | | |
| Class 43 | 35 | 36 | 39 | 41 | 42 | 43 | 30 | 40 | | | | | | | |
| Class 44 | 37 | 42 | 44 | 45 | | | | | | | | | | | |
| Class 45 | 9 | 42 | 44 | 45 | | | | | | | | | | | |

As is apparent from the above cross class table, class 9 is related to classes 16, 28, 37, 38, 41, 42, 45 and 11. As such, were the trade mark applicant to select class 9, the back-end server 305 is adapted to search not only for potentially conflicting trade marks with in class 9 but also within the cross classes. An exemplary SQL query may be provided as:

SELECT * FROM trade marks JOIN classes
USING(number) WHERE MATCH(representation) AGAINST
(“GOPRO”) AND (class=9 OR class=16 OR
class=28 OR class=37 OR class=38 OR class=41 OR class=
45 OR class=11)

It should be noted that in certain embodiments, especially where the trade mark database 310 is provided as a web service as alluded to above, that may not be possible to search within a plurality of classes simultaneously. In this manner, the back-end server 305 would be configured to perform a search against the trade mark database 310 in the first class (e.g. class 9) and then perform subsequent trade mark searches against the trade mark database 310 against each other trade mark class (e.g. classes 16, 28, 37, 38, 41, 42, 45 and 11). However, so as to prevent unnecessary hits against the database 310, the back-end server 310 may allocate those search results received in respect of class 9 against the cross-classes so as to avoid having to perform a search again against the trade mark database 310. As such, in this manner, the back-end server 305 may be adapted for performing a single search against the trade mark database 310 so as to search for potentially conflicting trade marks against all classes 9, 16, 28, 37, 38, 41, 42, 45 and 11, despite the trade mark database 310 being limited for searching with and a single class at a time.

It should be noted that in certain embodiments, the back-end server 305 may be adapted to search for potentially conflicting trade marks within two classes that are not related by cross class correlation. For example, the trade mark applicant may have selected class 9 and class 6, which as is evident from the above cross class table are not related. As such, the back-end server 305 would perform a first search against the trade mark database 310 in respect of class 9 and a second search against the trade mark database 310 in respect of class 6. It should be noted however from a web perspective, time limitations apply for performing HTTP requests and were the back-end server 305 to perform multiple queries against the trade mark database 310 in respect of different classes (each of which may take a not insubstantial amount of time), there is a danger that the trade mark search query would timeout and an error would be displayed for the trade mark applicant. As such, the back-end server 305 and the browser application 280 are adapted to “bounce backwards and forwards” while performing a search against each class specifically, the browser application 280 would send a trade mark search query to the back-end server 305 in respect of class 9 and class 6. The back-end server 305 would then perform the trade mark search query against the trade mark database 310 in respect of class 9 only and return the results back to the browser application 280, the results indicating to the trade mark applicant that class 9 had been searched but not class 6. The browser application 280, would be configured to realise that the was an outstanding search result in respect of class 6 so as to send a further trade mark search query to the back-end server 305 allowing sufficient time for the back-end server to perform a further trade mark search query against trade mark database 310 in respect of class 6. The back-end server 305 would then return the search results to the browser application 280 for display, thereby completing the trade mark availability searching within classes 9 and 6.

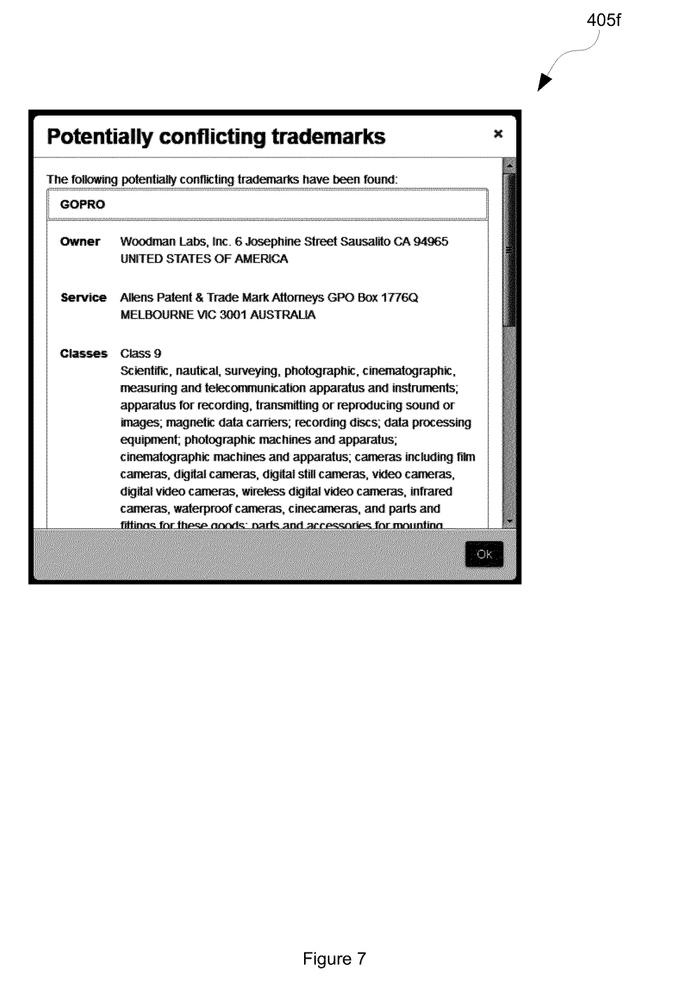

Referring to the exemplary interface 405e as substantially shown in FIG. 6, each trade mark search result may be presented as a hyperlink, for which the clicking of the hyperlink would display the pop-up interface 405f as substantially shown in FIG. 7 comprising the bibliographic details in relation to each potentially conflicting trade mark found. In this manner, the trade mark applicant would be able to review each of the potentially conflicting trade marks so as to form an opinion as to whether the trade marks are potentially conflicting, or whether they could be ignored. The interface 405f may represent a plurality of potentially conflicting trade marks displayed within a “concertina” control, wherein clicking on each potentially conflicting trade mark would expand the concertina to display the bibliographic detail in relation to the selected trade mark. The retrieval of the bibliographic details for a selected trade mark is preferably performed asynchronously wherein, upon the display event for each of the items within the concertina control, the browser application 280 would be adapted to perform an asynchronous request to the back-end server 305 to obtain the bibliographic details. It should be noted that the back-end server 305 may be adapted to request the bibliographic details from the trade mark database 310 at this time, or may have alternatively stored the bibliographic details within an appropriate session variable or the like while performing the earlier trade mark search.

In a preferred embodiment, the browser application 280 is adapted to present a “storyboard” to the trade mark applicant comprising a first interface allowing the user to input and confirm availability of a trade mark application as substantially shown in FIG. 4, a subsequent screen allowing the trade mark applicant to input the trade mark applicant details, contact information and the like, and a review screen allowing the trade mark applicant to review the trade mark application details.

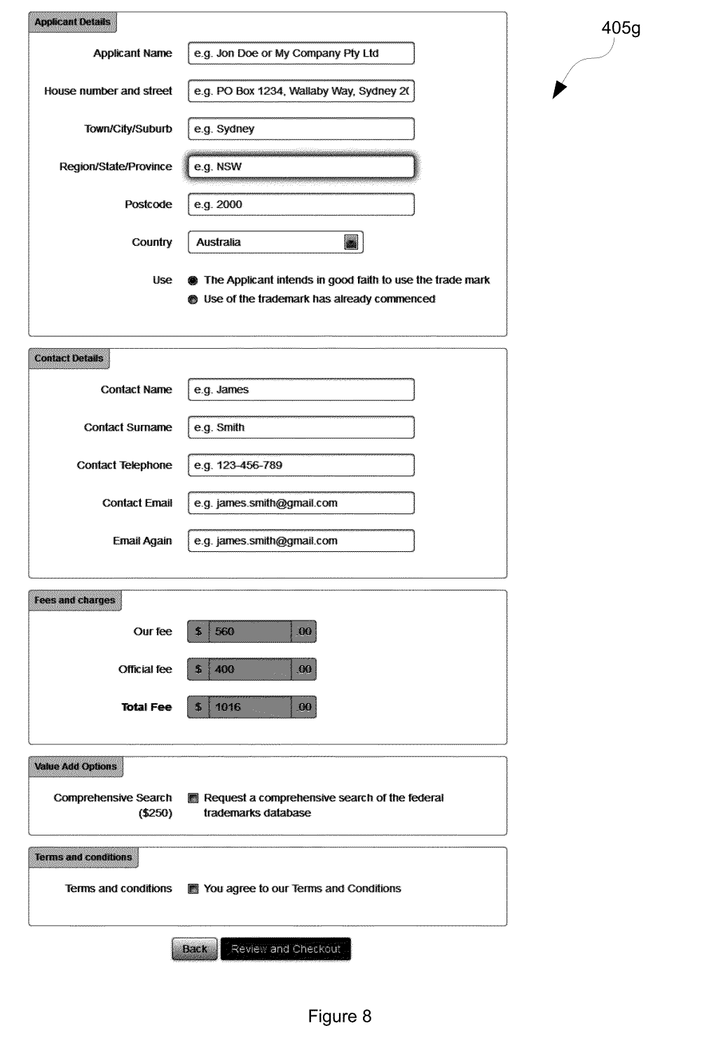

Specifically, referring to the exemplary interface 405g as substantially shown in FIG. 8, there is shown the interface 405g configured for allowing the trade mark applicant to input various information in relation to the trade mark application. It should be noted that the various screens of the storyboard may be navigated forwards and backwards by the trade mark applicant by use of suitable “back”, “forward” buttons and the like.

The interface 405g allows the trade mark applicant to input various data relating to the trade mark application. Specifically, the interface 405g comprises a first portion allowing the trade mark applicant to input information relating to the trade mark applicant. Specifically, the applicant details portion is adapted for allowing the trade mark applicant to input the name and address of the trade mark applicant. Also, the applicant details portion comprises a youth statement allowing the user to indicate whether the trade mark applicant intends to use the trade mark or whether use of the trade mark has already occurred. Where the user selects the option indicating that use of the trade mark has already occurred, the interface 405g is configured to display a date picker allowing the trade mark applicant to pick a date indicating the first use of the trade mark.

The interface 405g further comprises a contact details portion allowing the trade mark applicant to input contact details for receiving correspondence and the like in respect of the trade mark application. Typically, the contact details comprises the name of the contact, and contact information including the telephone and e-mail details for the contract.

The interface 405g further comprises a fees and charges portion displaying the charges and fees in relation to the trade mark application. Is presented in the exemplary interface 405g the fees are divided between the trade mark service provider fees and the government fee. It should be noted that these fees and charges (and other aspects of the trade mark application interface” are configured by the trade mark service provider using the trade mark service provider backend as will be described in further detail below. In this manner, the trade mark service provider is able to set the appropriate fees and charges to be levied against each trade mark applicant when applying for a trade mark application.

The interface 405g further comprises a value added options portion allowing the trade mark applicant to select value add options in relation to the trade mark application. Similarly in the manner described above the trade mark service provider is able to configure the back-end so as to propose these value add options to the trade mark applicant. As is evident, the trade mark service provider has configured the back-end so as to offer an additional service offering a comprehensive search of the trade marks register for a fee of $250. Should the trade mark applicant to select such an option, the fees and charges portion may be adapted to reflect the new fee. Furthermore, the back-end as will be described in further detail below will be configured to split the trade mark service provider those option selected by each trade mark applicant.

Finally, the interface 405g comprises a terms and conditions portion requiring the trade mark applicant to agree to the terms and conditions for which the trade mark application service is provided. Similarly, the terms and conditions may be edited by the trade mark service provider using the back-end as will be described in further detail below.

It should be noted that the interface 405g may comprise other portions for the purposes of displaying other information in relation to the trade mark application.

Having input the details into the interface 405g the trade mark applicant is able to utilise the review and checkout button to review the trade mark application details and checkout. In the review screen, the trade mark application details will be presented to the user for inspection, including the proposed trade mark application, the selected goods and services, and the information input into the interface 405g. Should the trade mark applicant spot an error, the trade mark applicant may utilise the “back” button to correct the error.

Having reviewed the trade mark application details, the trade mark applicant is then able to make payment for the trade mark application. In a preferred embodiment, the back-end server 305 is adapted to interface with a third-party financial transaction processing platform, such as PayPal or the like. As such, by clicking the “pay button” the browser application is preferably configured to redirect to and a perfect landing page of the financial processing platform so as to allow the trade mark applicant to make payment, such as by credit card or the like.

In a preferred embodiment, the back-end server 305 is adapted to deduct a commission against each trade mark application from the trade mark service provider fees. As such, the back-end server 305 is adapted to implement a “chained payment” wherein multiple receivers receive payment, these receivers being the operator of the back-end server 305 and the trade mark service provider. In one embodiment, the back-end server 305 is adapted to send chained payment configuration data to the financial processing platform so as to establish the chained payment, so as to receive from the financial processing platform and authentication key uniquely identifying the configured chained payment. Upon receipt of the key, the browser application 280 would be configured to redirect to the financial processing platform to complete the chained payment.

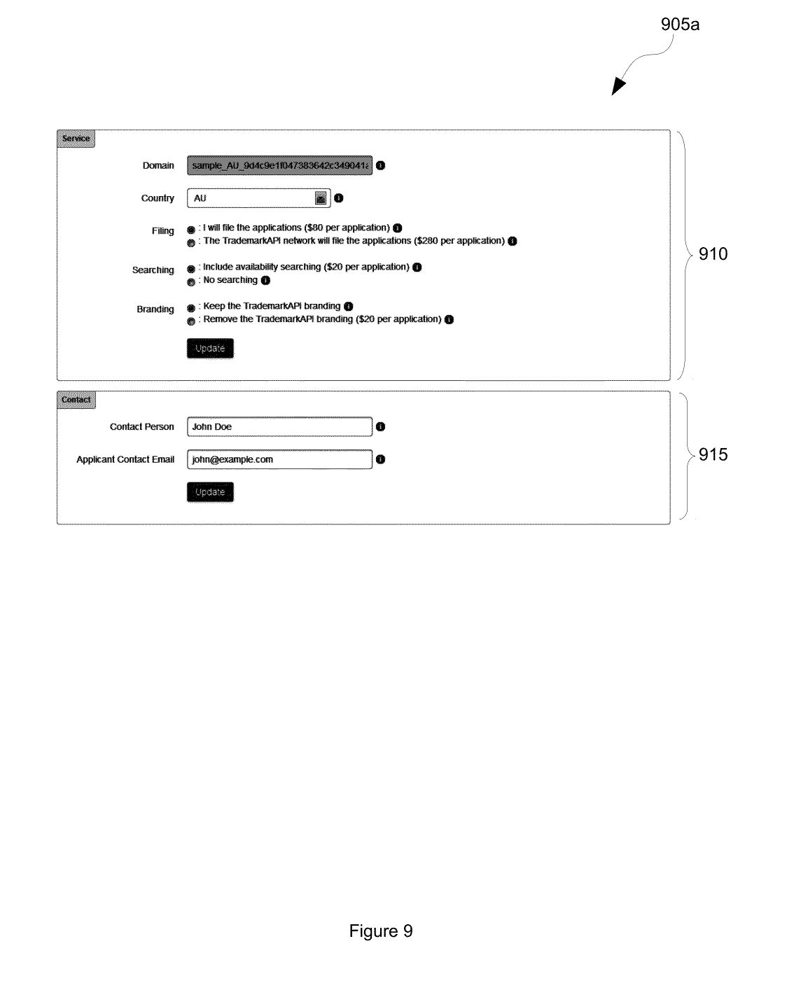

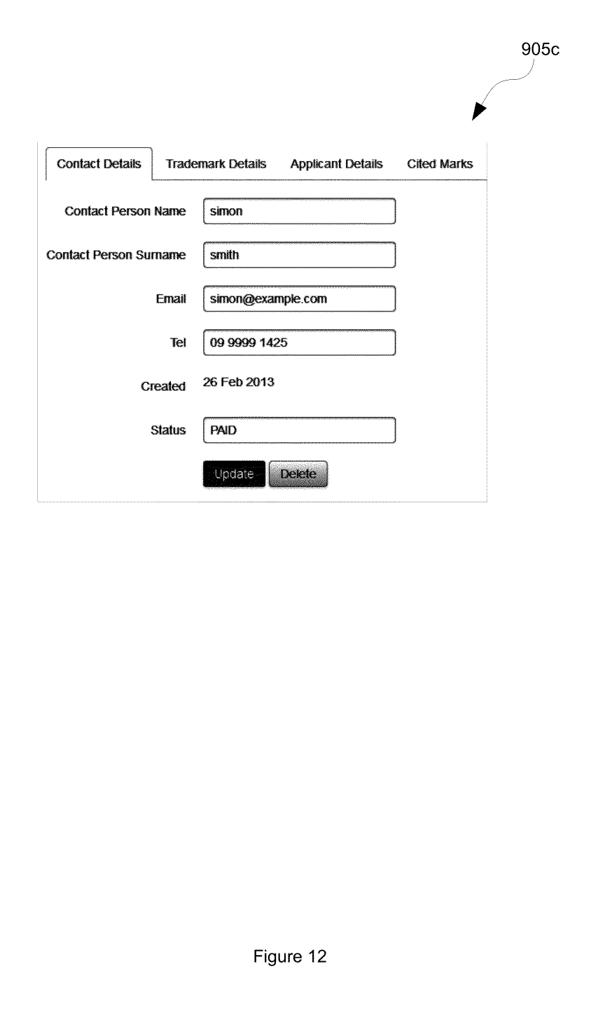

Reference will now be made to FIGS. 9 to 15 showing the “back-end” for use by the trade mark service provider in configuring the trade mark application interface 405, reviewing trade mark application details and the like.

As will be described in further detail below, the trade mark service provider will use the back-end to configure various aspects, such as the trade mark application fees and charges and the like such that the back-end server 305 is adapted to configure the interface markup plan which data accordingly.

Specifically, the back-end server 305 to configure the interface markup language data in accordance with a configuration setting. In one embodiment the back-end server 305 is adapted to receive, from the browser application via the network interface, the configuration setting. For example, such configuration settings may be configured as JavaScript variables. However, such an implementation is a less preferred implementation, as it essentially requires the trade mark service provider to configure JavaScript files which may not be within the technical scope of many trade mark service provider.

However, in a preferred embodiment, the at least one configuration setting stored in relation to the trade mark service provider id, and wherein the processor is further controlled by the computer program code to identify the trade mark service provider id in accordance with the cross domain request; and select, from the configuration data, the at least one configuration setting in accordance with the trade mark service provider id.

For example, the back-end server 305 may be configured to code to identify the trade mark service provider id in accordance with the domain of the cross domain request. For example, the back-end server 305 may be adapted to inspect the HTTP_ORIGIN, HTTP_REFERRER header or the like, so as to be able to identify the domain or webpage from which the request is received. Such an approach removes the requirement for configuring the single line of JavaScript with the service provider ID's or the like.

Preferably, each trade mark service provider who implements the trade mark application interface 405 will be required to go through the registration process prior to the back-end server 305 serving the trade mark application interface 405. In one manner, where a trade mark service provider includes the bootstrap file on a webpage, the back-end server 305 is adapted to determine whether the domain of the trade mark service provider is registered. If not, the back-end server 305 is adapted to configure the trade mark application interface 405 to represent that the domain is not yet registered, and providing a link to the trade mark service provider to register with the back-end server. Preferably, such registration comprises the trade mark service provider inputting contact information for the trade mark service provider, such as an e-mail address, and configuring a password for secure authentication.

Preferably, the registration process also requires the trade mark service provider to select a jurisdiction. Specifically, the trade mark database 310 may be configured with trade mark data from various countries. Alternatively, the back-end server may be adapted to communicate with different trade mark databases according to a selected country. In this manner, should the trade mark service provider choose the country Australia, the back-end server 305, upon receiving a request from the browser application from the domain of the trade mark service provider, would select the configuration setting that the trade mark service provider wishes to provide trade mark availability searching from Australia, so as to ascertain that the trade mark database 310 from Australia should be searched.

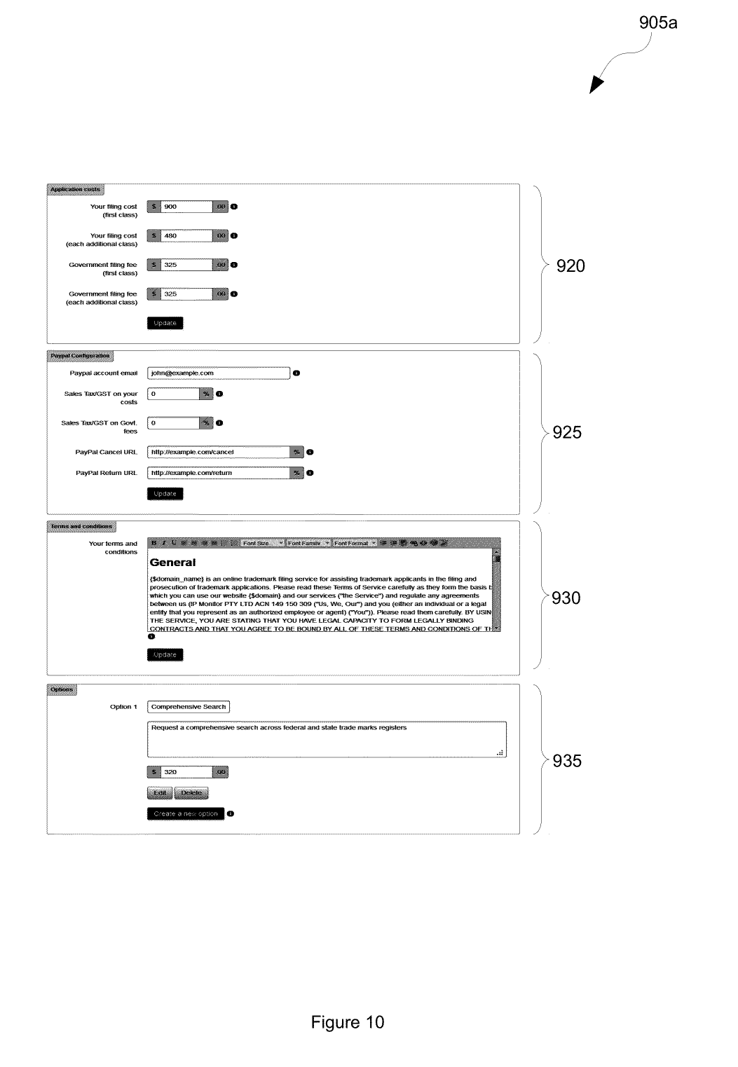

Referring now to the exemplary “back-end” interface 905a as substantially shown in FIGS. 9 and 10, there is shown the interface 905a allowing the trade mark service provider to configure the trade mark application interface 405. As alluded to above, the configuration of the trade mark application interface 405 by the trade mark service provider in this manner is a preferred embodiment, however alternative embodiments may be implemented for allowing the trade mark service provider to configure the trade mark application interface 405, including by setting JavaScript variables within the bootstrap or other JavaScript file, in a less preferred embodiments

The interface 905a would only be accessible to the trade mark service provider upon receipt of authentication credentials such as e-mail address and password.

The interface 905a comprises a service portion 910 allowing the trade mark applicant to select a country for trade mark availability searching. As is apparent, from the example, the trade mark service provider has selected Australia. In this manner, the back-end server 305 would be adapted to search and Austrian trade mark database 310 for potentially conflicting trade marks. It should be noted that the selection of a country need not necessarily be limited to selecting the appropriate trade mark database 310 for trade mark availability searching. Specifically, each country may have differing recommended goods and services, oftentimes referred to as the official pick list. As such, the back-end server 305 may furthermore be configured to perform goods and services searching against the appropriate goods and services database in accordance with the country. As is apparent from the service portion 910, the service portion 910 further comprises the domain, which is represented in the exemplary embodiment as being disabled, as the trade mark service provider is disallowed from changing the domain. Furthermore, the service portion 910 may further represent to the chosen e-mail address for the trade mark service provider, which may similarly be disabled.

The service portion 910 further comprises various options for the trade mark service provider, represented as filing, searching and branding options in the exemplary service portion 910. These options generally affect the commission levied by the back-end server when processing the financial transaction in the manner described above. Specifically, the service portion 910 comprises a first option relating to filing options for the trade mark service provider, either allowing the trade mark service provider to file received trade mark applications or alternatively requesting that received trade mark applications are referred to network trade mark service providers for handling. In this manner, the trade mark filing interface 405 may be used by trade mark service providers and nonprofessionals. In the exemplary embodiment, the back-end server 305 is adapted to levy a commission of $80 where the trade mark service provider files a trade mark application, or $280 where the trade mark application is to be filed by the trade mark filing network, the higher commission for the latter primarily for covering the professional fees of the trade mark attorney of the trade mark filing network.

The service portion 910 further comprises a searching option configurable to perform availability searching in the manner described above or not. As is apparent, the back-end server 305 is adapted to levy a commission of $20 for such availability searching over and above the above-mentioned filing commission.

Yet further, the service portion 910 further comprises a branding option configurable by the trade mark service provider to cause the back-end server 305 to either display or hide branding for the back-end server 305 service, such branding primarily used for advertising purposes for the back-end server 305 service.

The interface 905a further comprises a contact portion 915 allowing the trade mark applicant to input contact information for the trade mark service provider. The contact portion manage and 15, allows the trade mark service provider to input the name of the contact person and the applicant contact e-mail. Such information would primarily be used for allowing trade mark applicant to contact the trade mark service provider should the trade mark applicant has a question. In this manner, the trade mark application interface 405 would be configured to present the applicant contact e-mail to the trade mark applicant, allowing the trade mark applicant to contact the trade mark service provider directly.

Turning now to FIG. 10, the interface 905a further comprises an application costs portion 920 allowing the trade mark service provider to configure the charges levied by the trade mark service provider or for each trade mark application and the government fee is levied by the government for each trade mark application. As is apparent, the application costs portion 920 allows the trade mark service provider to configure charges and fees in respect of the first trade mark class and separately for each additional trade mark class. In this manner, the application costs portion 920 is configured for catering for jurisdictions, such as the United Kingdom, where the government charges differing fees for the first trade mark class and each subsequent trade mark class.

The interface 905a further comprises a financial transaction processing platform configuration portion 925, herein referred to as the PayPal configuration portion, where PayPal is used. However, it should be noted that other financial transaction processing platforms may be employed.

The PayPal configuration portion 925 comprises the e-mail of the PayPal account such that the back-end server 305 may direct funds received from a trade mark applicant to the PayPal account of the trade mark service provider, less the commission charged by the back-end server 305. The PayPal configuration portion 925 further comprises input fields allowing the trade mark service provider to configure whether GST, sales tax, VAT or the like is to be charged to the trade mark applicant. Furthermore, the PayPal configuration portion 925 further comprises URLs to which the PayPal platform is to return the trade mark applicant upon successful completion of a payment, or cancellation of payment.

The interface 905a further comprises a terms and conditions portion 930 allowing the trade mark service provider to edit the terms and conditions to which the trade mark applicant must agree prior to submitting a trade mark application. As is apparent, the terms and conditions portion 930 comprises a rich text editor allowing the trade mark service provider to configure the terms and conditions and a substantially WYSIWYG manner.

Furthermore, the interface 905a comprises a value add options portion 935 allowing the trade mark service provider to configure at least one value and option to be presented to the trade mark applicant in the trade mark filing interface 905. Using the value add options portion 935, the trade mark service provider may create new options or edit or delete existing options. As is apparent, the value add options portion 935 comprises one option having a title “comprehensive search” and a description indicating that the comprehensive search relates to a search across Federal and State trade mark registers. Furthermore, the value add options portion 935 further comprises a cost input portion allowing the trade mark service provider to input the cost for the option, given as $320 in the example.

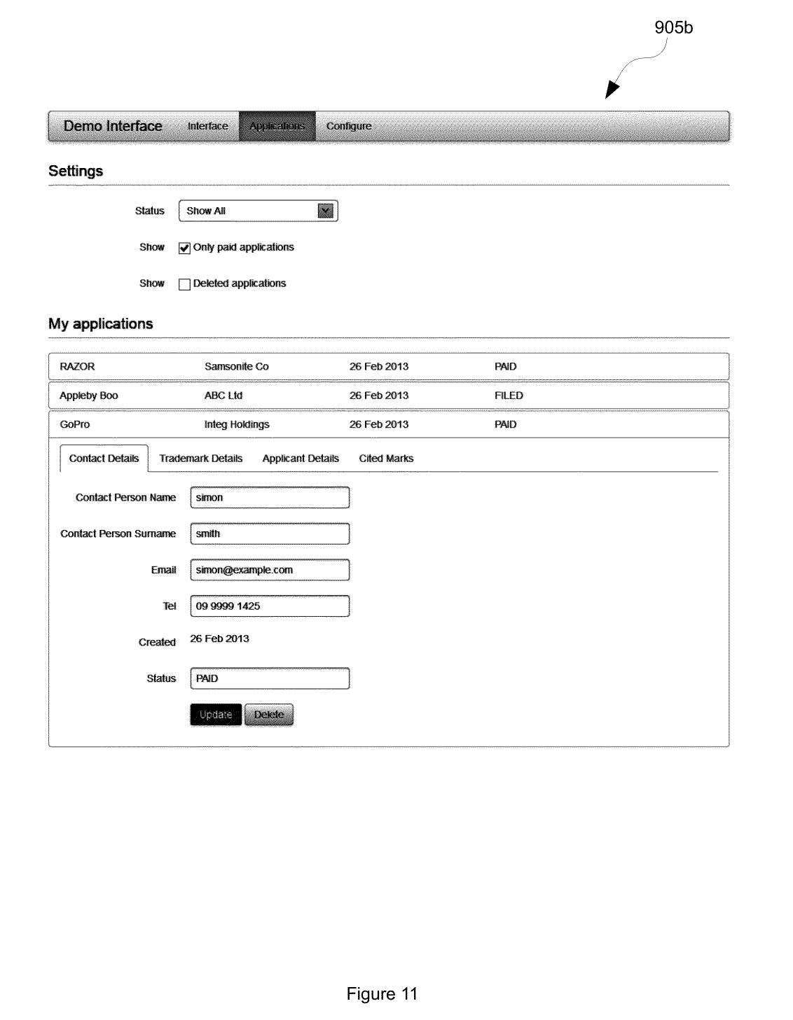

Referring now to FIG. 11, there is shown an exemplary back-end interface 905b allowing the trade mark service provider to review and manage received trade mark application. Specifically, the interface 905b comprises a settings portion allowing the trade mark service provider to control the display settings of the below trade mark applications. Specifically, the cities portions allows the trade mark service provider to display the trade mark applications in accordance with status, which status is configurable by the trade mark service provider. For example, the trade mark service provider may choose to display all trade mark applications, or only those trade mark applications which are pending filing.

Furthermore, the settings portions allows the trade mark service provider to display only those trade mark applications which have been paid. Specifically, the back-end server 305 is adapted to implement a payment listener to listen for payments from the financial transaction processing platform. Upon receipt of a payment notification, the back-end server 305 is adapted to update the database of trade mark applications to reflect that the trade mark application has been paid. In this manner, the interface 905b is adapted for allowing the trade mark service provider to filter only those trade mark applications which have been paid.

Furthermore, the settings portions allows the trade mark service provider to display those trade mark applications which have been deleted. In a preferred embodiment, and so as to substantially prevent accidental deletion, trade mark applications are not actually deleted from the database of the back-end server 305, but are merely flagged has been deleted. In this manner, by selecting the show deleted applications settings option the trade mark service provider is able to view the delete applications.

The interface 905b further comprises an applications portion showing the trade mark applications which have been received in respect of the domain of the trade mark service provider. As is apparent, each trade mark application is similarly shown in concertina formats, allowing the trade mark service provider to chill down into further detail is required. As is apparent, the trade mark service provider has received three trade mark applications, comprising trade mark applications for “RAZOR”, “Appleby Boo” and “GoPro”. It should be noted that where design/logo trade mark applications have been received, an appropriate thumbnail may be displayed also.

Each concertina header further next displays the name of the applicant, the date upon which the trade mark application was received and the current status of the trade mark application.

Upon selection of each concertina header, each concertina header will expand to show specific trade mark application details in respect of a selected trade mark which will now be described with reference to figure is 12 to 15.

Specifically, the interface 905 comprises a contact details tab 905c showing the contact details for the trade mark application. The contact details tab 905 further comprises a status input field allowing the trade mark service provider to input the current status of the trade mark application, allowing the trade mark service provider to implement a simple docketing system.

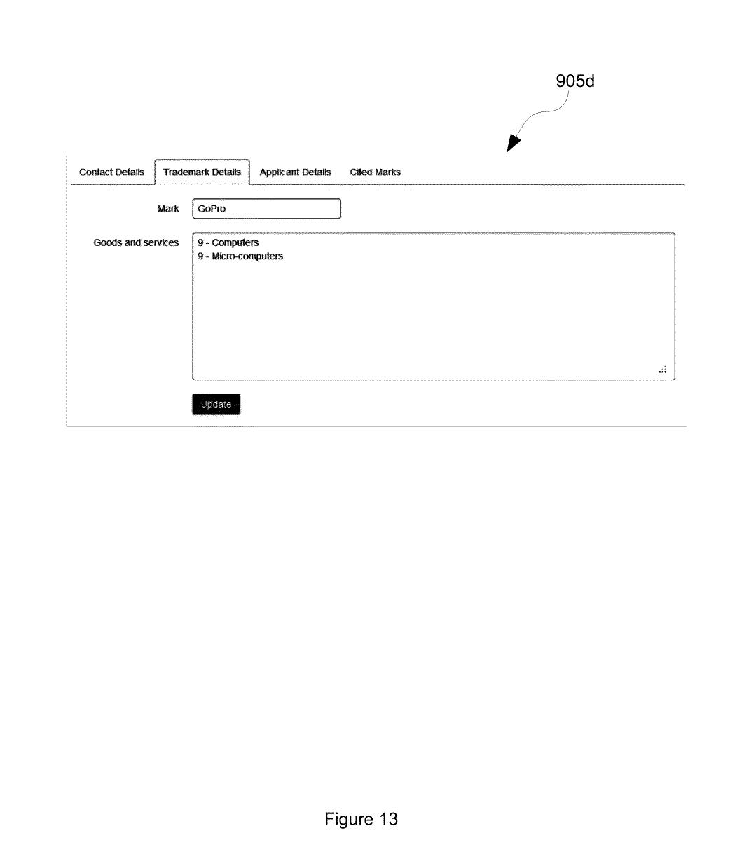

Turning now to FIG. 13, the interface 905 further comprises trade mark details tab 905d showing the details in respect of the trade mark. As is apparent from the exemplary interface 905d, the trade mark details tab 905d is adapted to display the trade mark representation and the goods and services. As is apparent, the trade mark details represent that the trade mark for “GoPro” has been selected in respect of two goods and service items in class 94 computers and microcomputers. The interface 905d is adapted for allowing the trade mark service provider to edit the goods and services items wherein the back-end server 305 is adapted for parsing the class number followed by the “-”, followed by the goods and service string.

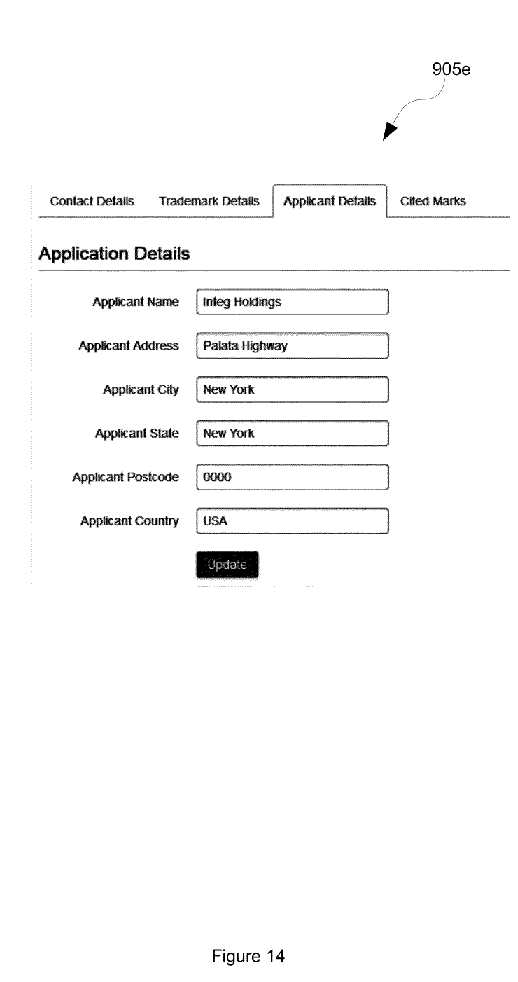

Turning now to FIG. 14, the interface 905 further comprises applicant details tab 905e displaying the trade mark applicant details received in respect of the trade mark application. The applicant details tab 905e is adapted to allow the trade mark service provider to update any of the data therein as need be.

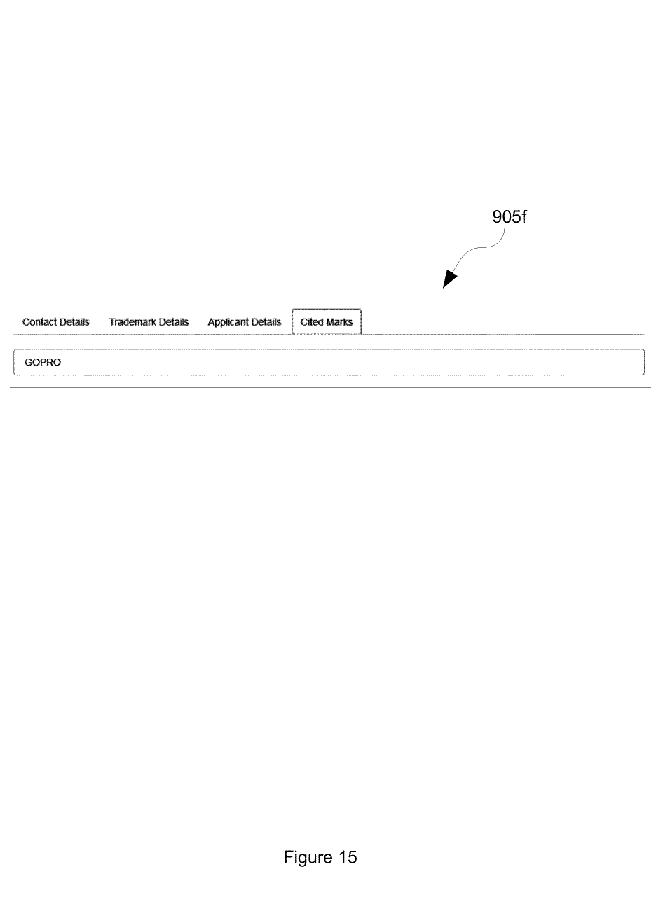

Turning now to FIG. 15, the interface 905 further comprises a cited Marks portion 905f displaying the potentially conflicting trade marks ascertained by the back-end server 905 during the trade mark application process. In this manner, the trade mark service provider may review any potentially conflicting trade mark found by the back-end server so as to make a professional opinion as to whether the potentially conflicting trade marks would in fact be considered potentially conflicting during examination. In a similar manner, any potentially conflicting trade mark is displayed in concertina format, allowing the concertina header to be selected for the purposes of expanding and displaying the bibliographic details in relation to the potentially conflicting trade mark in the manner described above.

Yet further, the interface 905 may further comprises a notes portion for displaying warnings or notes to the trade mark service provider. For example, were the back-end server 305 is not able to find an appropriate class for a trade mark applicants input goods and service string, the interface 905 may comprise a warning that the trade marks professional should doublecheck the goods and services input strings to ascertain the most appropriate class. Yet further, should the trade mark database 310 be down or otherwise unavailable during the trade mark availability searching process in the manner described above, the back-end server 305 may be configured to not necessarily represent such to the trade mark applicant so as to dissuade the trade mark applicant from applying for a trade mark. Rather, the back-end server 305 may be adapted to display a warning to the trade mark service provider that the trade mark database was unavailable and that the trade marks professional should perform a supplementary search.

### Interpretation

### Cross Domain

It should be noted that while the term “cross domain” as used herein is preferably a cross-origin resource sharing (CORS) as per the W3C recommendations (or note as the case may be), it should be noted that “cross domain” should not be construed as being limited to this technical implementation. Rather, the term “cross domain” should be construed as any request (whether HTTP, FTP, by way of GET, POST, in SOAP, JSON or HTML format and the like) from a webpage to another domain. Such a cross domain requests may be implemented also by way of iFrame. Furthermore, specifically included within the definition of “cross domain” as used herein is a request from a webpage back to the server of the webpage, wherein the server makes a request to a server so as to serve the webpage with the requested information.

### Bus

In the context of this document, the term “bus” and its derivatives, while being described in a preferred embodiment as being a communication bus subsystem for interconnecting various devices including by way of parallel connectivity such as Industry Standard Architecture (ISA), conventional Peripheral Component Interconnect (PCI) and the like or serial connectivity such as PCI Express (PCIe), Serial Advanced Technology Attachment (Serial ATA) and the like, should be construed broadly herein as any system for communicating data.

In Accordance with:

As described herein, ‘in accordance with’ may also mean ‘as a function of’ and is not necessarily limited to the integers specified in relation thereto.

### Composite Items

As described herein, ‘a computer implemented method’ should not necessarily be inferred as being performed by a single computing device such that the steps of the method may be performed by more than one cooperating computing devices.

Similarly objects as used herein such as ‘web server’, ‘server’, ‘client computing device’, ‘computer readable medium’ and the like should not necessarily be construed as being a single object, and may be implemented as a two or more objects in cooperation, such as, for example, a web server being construed as two or more web servers in a server farm cooperating to achieve a desired goal or a computer readable medium being distributed in a composite manner, such as program code being provided on a compact disk activatable by a license key downloadable from a computer network.

### Database:

In the context of this document, the term “database” and its derivatives may be used to describe a single database, a set of databases, a system of databases or the like. The system of databases may comprise a set of databases wherein the set of databases may be stored on a single implementation or span across multiple implementations. The term “database” is also not limited to refer to a certain database format rather may refer to any database format. For example, database formats may include MySQL, MySQLi, XML or the like.

### Wireless:

The invention may be embodied using devices conforming to other network standards and for other applications, including, for example other WLAN standards and other wireless standards. Applications that can be accommodated include IEEE 802.11 wireless LANs and links, and wireless Ethernet.

In the context of this document, the term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. In the context of this document, the term “wired” and its derivatives may be used to describe circuits, devices, systems, methods, techniques, communications channels, etc., that may communicate data through the use of modulated electromagnetic radiation through a solid medium. The term does not imply that the associated devices are coupled by electrically conductive wires.

### Processes:

Unless specifically stated otherwise, as apparent from the following discussions, it is appreciated that throughout the specification discussions utilizing terms such as “processing”, “computing”, “calculating”, “determining”, “analysing” or the like, refer to the action and/or processes of a computer or computing system, or similar electronic computing device, that manipulate and/or transform data represented as physical, such as electronic, quantities into other data similarly represented as physical quantities.

### Processor:

In a similar manner, the term “processor” may refer to any device or portion of a device that processes electronic data, e.g., from registers and/or memory to transform that electronic data into other electronic data that, e.g., may be stored in registers and/or memory. A “computer” or a “computing device” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. The processing system further may include a memory subsystem including main RAM and/or a static RAM, and/or ROM.

### Computer-Readable Medium:

Furthermore, a computer-readable carrier medium may form, or be included in a computer program product. A computer program product can be stored on a computer usable carrier medium, the computer program product comprising a computer readable program means for causing a processor to perform a method as described herein.

### Networked or Multiple Processors:

In alternative embodiments, the one or more processors operate as a standalone device or may be connected, e.g., networked to other processor(s), in a networked deployment, the one or more processors may operate in the capacity of a server or a client machine in server-client network environment, or as a peer machine in a peer-to-peer or distributed network environment. The one or more processors may form a web appliance, a network router, switch or bridge, or any machine capable of executing a set of instructions (sequential or otherwise) that specify actions to be taken by that machine.

Note that while some diagram(s) only show(s) a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

### Additional Embodiments

Thus, one embodiment of each of the methods described herein is in the form of a computer-readable carrier medium carrying a set of instructions, e.g., a computer program that are for execution on one or more processors. Thus, as will be appreciated by those skilled in the art, embodiments of the present invention may be embodied as a method, an apparatus such as a special purpose apparatus, an apparatus such as a data processing system, or a computer-readable carrier medium. The computer-readable carrier medium carries computer readable code including a set of instructions that when executed on one or more processors cause a processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

### Carrier Medium:

The software may further be transmitted or received over a network via a network interface device. While the carrier medium is shown in an example embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media.

### Implementation:

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

### Means for Carrying Out a Method or Function

Furthermore, some of the embodiments are described herein as a method or combination of elements of a method that can be implemented by a processor of a processor device, computer system, or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

### Connected

Similarly, it is to be noticed that the term connected, when used in the claims, should not be interpreted as being limitative to direct connections only. Thus, the scope of the expression a device A connected to a device B should not be limited to devices or systems wherein an output of device A is directly connected to an input of device B. It means that there exists a path between an output of A and an input of B which may be a path including other devices or means. “Connected” may mean that two or more elements are either in direct physical or electrical contact, or that two or more elements are not in direct contact with each other but yet still co-operate or interact with each other.

### Embodiments

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

### Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

### Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### INDUSTRIAL APPLICABILITY

It is apparent from the above, that the arrangements described are applicable to the IP management software industries.

1. A server for serving a cross domain trade mark application interface, the server comprising:
a processor for processing digital data;
a memory device for storing digital data including computer program code, the memory device being operably coupled to the processor; and
a network interface for sending and receiving data across a network, the network interface being operably coupled to the processor, wherein in use, the processor is controlled by the computer problem code to:
serve, in response to a cross domain request received via the network interface from a browser application, interface markup language data, the interface markup language data defining at least a portion of the trade mark application interface, the trade mark application interface comprising at least one input field for inputting trade mark application data, the trade mark application data representing at least a trade mark representation; and
receive, from the browser application via the network interface, the trade mark application data.

2. A server as claimed in claim 1, wherein the processor is further controlled by the computer program code to:
store the trade mark application data in relation to a trade mark service provider id, the trade mark service provider id uniquely representing a trade mark service provider.

3. A server as claimed in claim 1, wherein the processor is further controlled by the computer program code to:
receive, from the browser application via the network interface, trade mark search query data, the trade mark search query data comprising at the least trade mark representation; and
select, from trade mark database, trade mark search results data at least in accordance with the trade mark representation input data; and
serve, to the browser application via the network interface, the trade mark search results data.

4. A server as claimed in claim 3, wherein the processor is controlled by the computer program code to select the trade mark search results data in accordance with a similarity algorithm.

5. A server as claimed in claim 4, wherein the similarity algorithm compares phonetic indices.

6. A server as claimed in claim 1, wherein the processor is further controlled by the computer program code to configure the interface markup language data in accordance with a configuration setting.

7. A server as claimed in claim 6, wherein the processor is controlled by the computer program code to:
receive, from the browser application via the network interface, the configuration setting.

8. A server as claimed in claim 6, wherein the memory device comprises configuration data representing the configuration setting, the at least one configuration setting stored in relation to the trade mark service provider id, and wherein the processor is further controlled by the computer program code to:
identify the trade mark service provider id in accordance with the cross domain request; and
select, from the configuration data, the at least one configuration setting in accordance with the trade mark service provider id.

9. A server as claimed in claim 8, wherein the processor is controlled by the computer program code to identify the trade mark service provider id in accordance with the domain of the cross domain request.

10. A server as claimed in claim 9, wherein the processor is controlled by the computer program code to identify the trade mark service provider id in accordance with the HTTP_ORIGIN or HTTP_REFERRER header of the cross domain request.

11. A server as claimed in claim 6, wherein the configuration setting represents a selected country, and wherein the processor is further controlled by the computer program code to select, from the trade mark database, the trade mark search results data further in accordance with the selected country.

12. A server as claimed in claim 6, wherein the configuration setting represents a fee in relation to at least one of a trade mark application, a value added service and search option.

13. A server as claimed in claim 2, wherein the trade mark application interface comprises a goods and service input control for configuring at least one goods or service and wherein the trade mark search query data further comprises goods and service data and wherein the processor is further controlled by the computer program code to:
select, from the trade mark database, the trade mark search results data further in accordance with the goods and service data.

14. A server as claimed in claim 13, wherein the goods and service data comprises at least one goods or service string, and wherein the processor is further controlled by the computer program code to:
select, from a goods and service database, goods and service classification data representing at least one goods and service classification in accordance with the goods or service string; and
send, to the browser application via the network interface, the goods and service classification data.

15. A server as claimed in claim 13, wherein the trade mark search query data further comprises goods and service classification data and wherein the processor is further controlled by the computer program code to:
select, from the trade mark database, the trade mark search results data further in accordance with the goods and service classification data.

16. A server as claimed in claim 13, wherein the processor is further controlled by the computer program code to:
select cross class classification data in accordance with the goods and service data; and
select, from the trade mark database, the trade mark search results data further in accordance with the cross class classification data.

17. A server as claimed in claim 16, wherein the server is adapted to search the trade marks database in accordance with a first class of the classification data, and associate the trade mark search results with the cross class classification data.

18. A server as claimed in claim 1, wherein the processor is further controlled by the computer program code to:
send, to a financial transaction processing server via the network interface, financial transaction initiation instruction data.

19. A server as claimed in claim 18, wherein the financial transaction initiation instruction data represents an instruction to pay a trade mark service provider.
